(19) United States
(12) Patent Application Publication
(10) Pub. No.: US 2012/0280823 A1
(43) Pub. Date: Nov. 8, 2012

(54) SYSTEM AND METHOD FOR DETECTING AND WARNING AGAINST A DISASTER

(76) Inventor: Yuanjie Yang, Shanghai (CN)

(21) Appl. No.: 13/512,728

(22) PCT Filed: Dec. 21, 2009
(86) PCT No.: PCT/CN2009/001513

§ 371 Date: Jul. 25, 2012

(30) Foreign Application Priority Data
Dec. 21, 2009 (CN) PCT/CN2009/001513

(51) Int. Cl. G08B 21/10; G08B 21/18; G06F 15/16

(52) U.S. Cl. 340/669; 340/540

(57) ABSTRACT

A method, device, and system for detecting the occurrence of a disaster event and providing a disaster warning to users is disclosed. In one embodiment, the method includes receiving a warning notification with an out-of-band (OOB) processor of a computing device. The warning notification may be received by the OOB processor while an in-band processor of the computing device is in a reduced-power state. The method also includes generating a user alert on the computing device in response to receiving the warning notification. The method may additionally include detecting the occurrence of a disaster event and transmitting data to a remote server in response to detection of the event.

### BACKGROUND

Many disasters cannot be adequately predicted and, thus, persons in danger from those disasters cannot be warned. For example, current seismographic science is only able to forecast earthquakes with a relatively high-rate of error (both false negatives and false positives). An alternative to disaster prediction is the approach of early detection and warning. Returning to the example of an earthquake, several seconds typically pass between the occurrence of primary waves (“P-waves”), which travel at about 6 kilometers per second but cause minimal damage, and the occurrence of Rayleigh waves (i.e., surface waves), which travel at about 3.5 kilometers per second but are significantly more destructive. The amount of time between the P-waves and the Rayleigh waves will vary according to a location's distance from the epicenter of the earthquake. If the P-waves related to a particular earthquake can be detected, a warning may be provided to at least some persons before the occurrence of the destructive Rayleigh waves, allowing these persons to seek immediate shelter.

Some countries have systems in place to warn citizens of impending disasters. For example, the Japan Meteorological Agency (www.jma.go.jp) operates an earthquake observation network comprised of about 200 seismographs and 600 seismic intensity meters that are monitored by the agency in real-time to detect the P-waves of any significant earthquakes. When an earthquake occurs, the agency is able to broadcast information regarding the earthquake's epicenter, magnitude, and observed seismic intensity. Currently, this information is delivered to affected persons via local media (e.g., television, radio, etcetera) or wireless devices (i.e., cellular telephones). Each of these possible sources of information, however, will only be able to warn a user when the receiving device is turned “on” and operational.

### BRIEF DESCRIPTION OF THE DRAWINGS

The invention described herein is illustrated by way of example, and not by way of limitation, in the accompanying figures. For simplicity and clarity of illustration, elements illustrated in the figures are not necessarily drawn to scale. For example, the dimensions of some elements may be exaggerated relative to other elements for clarity. In the following figures:

FIG. 1 is a simplified block diagram of one embodiment of a system configured to detect the occurrence of a disaster event and/or provide a disaster warning;

FIG. 2 is a simplified flow diagram of one embodiment of a method for providing a disaster warning used by the system of FIG. 1; and

FIG. 3 is a simplified flow diagram of one embodiment of a method for detecting a disaster and providing a disaster warning used by system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an illustrative embodiment,” etcetera, indicate that at least one embodiment described may include a particular feature, structure, or characteristic, but not every embodiment necessarily includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the disclosed systems and methods may be implemented in hardware, firmware, software, or any combination thereof. Embodiments of the disclosed systems and methods implemented in a computing device may include one or more bus-based interconnects between components and/or one or more point-to-point interconnects between components. Embodiments of the disclosed systems and methods may also be implemented as instructions stored on a tangible, machine-readable medium, which may be read and executed by one or more processors. A tangible, machine-readable medium may include any mechanism for storing or transmitting information in a form readable by a machine (e.g., a computing device). For example, a tangible, machine-readable medium may include read only memory (ROM), random access memory (RAM), magnetic disk storage, optical storage, flash memory, and/or other types of memory devices.

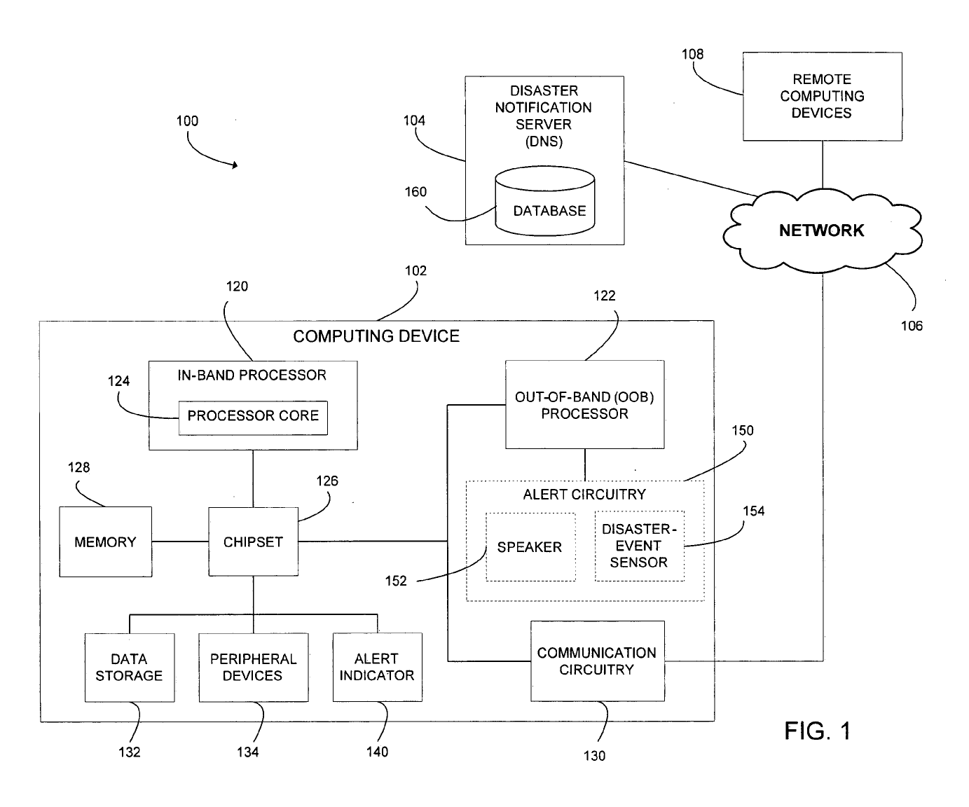

Referring now to FIG. 1, a system 100 configured to detect the occurrence of a disaster and provide a warning to users of the system 100 includes a computing device 102, a disaster notification server (DNS) 104, and a network 106 that communicatively connects the computing device 102 to the DNS 104. In some embodiments, the system 100 may also include one or more remote computing devices 108 connected, via the network 106, to the computing device 102 and to the DNS 104.

The computing device 102 may be embodied as any type of electronic device capable of performing the functions described herein. For example, the computing device 102 may be embodied as a personal computer, a workstation, a laptop computer, a handheld computer, a mobile internet device, a cellular phone, a personal data assistant, a telephony device, a network appliance, a virtualization device, a storage controller, or other computer-based device.

The computing device 102 includes an in-band processor 120, an out-of-band (OOB) processor 122, a chipset 126, a memory 128, and communication circuitry 130. In some embodiments, the computing device 102 may also include one or more data storage devices 132, one or more peripheral devices 134, an alert indicator 140, and/or alert circuitry 150. In some embodiments, several of the foregoing components may be incorporated on a motherboard of the computing device 102, while other components may be communicatively coupled to the motherboard via, for example, a peripheral port. Furthermore, it should be appreciated that the computing device 102 may include other components, sub-components, and devices commonly found in a computer and/or computing device, which are not illustrated in FIG. 1 for clarity of the description.

The in-band processor 120 of the computing device 102 may be any type of processor capable of executing software, such as a microprocessor, digital signal processor, microcontroller, or the like. The in-band processor 120 is illustratively embodied as a single core processor having a processor core 124. However, in other embodiments, the in-band processor 120 may be embodied as a multi-core processor having multiple processor cores 124. Additionally, the computing device 102 may include additional in-band processors 120 having one or more processor cores 124. The in-band processor 120 is generally responsible for executing a software stack, which may include an operating system and various applications, programs, libraries, and drivers resident on the computing device 102.

The chipset 126 of the computing device 102 may include a memory controller hub (MCH or “northbridge”), an input/output controller hub (ICH or “southbridge”), and a firmware device. In such embodiments, the firmware device may be embodied as a memory storage device for storing Basic Input/Output System (BIOS) data and/or instructions and/or other information. However, in other embodiments, chipsets having other configurations may be used. The chipset 126 is communicatively coupled to the in-band processor 120 via a number of signal paths. These signal paths (and other signal paths illustrated in FIG. 1) may be embodied as any type of signal paths capable of facilitating communication between the components of the computing device 102. For example, the signal paths may be embodied as any number of wires, cables, light guides, printed circuit board traces, vias, buses, intervening devices, and/or the like.

The memory 128 of the computing device 102 is also communicatively coupled to the chipset 126 via a number of signal paths. The memory 128 may be embodied as one or more memory devices or data storage locations including, for example, dynamic random access memory devices (DRAM), synchronous dynamic random access memory devices (SDRAM), double-data rate synchronous dynamic random access memory devices (DDR SDRAM), flash memory devices, and/or other volatile memory devices. Additionally, although only a single memory device 128 is illustrated in FIG. 1, in other embodiments, the computing device 102 may include additional memory devices. The operating system, applications, programs, libraries, and drivers that make up the software stack executed by the in-band processor 120 may reside in memory 128 during execution. Furthermore, software and data stored in memory 128 may be swapped between memory 128 and one or more data storage devices 132 as part of memory management operations.

The communication circuitry 130 of the computing device 102 may be embodied as any number of devices and circuitry for enabling communications between the computing device 102 and one or more remote devices (such as DNS 104 and remote computing devices 108) over the network 106. For example, the communication circuitry 130 may include one or more wired or wireless network interfaces to facilitate wired and/or wireless communications. Communication circuitry 130 is also communicatively coupled to the chipset 126 via a number of signal paths, allowing the in-band processor 120 to access the network 106. The computing device 102 is configured to communicate with the DNS 104 over the network 106, which may be wired and/or wireless as discussed below. Additionally, the one or more remote computing device 108 may be configured to communicate with the DNS 104 over the network 106.

The components of the computing device 102, including the in-band processor 120, the chipset 126, the memory 128, and the communication circuitry 130, are also operably coupled to a power supply (not shown). The power supply may be embodied as a circuit capable of drawing power from either an AC commercial source, a DC battery source, or both. To conserve energy, the computing device 102 may be placed in several reduced-power operational states when not being actively used. For example, the computing device 102 may be placed in a powered down or “off” state in which few, if any, components of computing device 102 receive power from the power supply. Alternatively, the computing device 102 may be placed into various “sleep” or “hibernate” states in which some, but not all, components of computing device 102 receive power from the power supply. For instance, a “sleep” state may provide power to a volatile memory 128 (in order to retain data) but not to the in-band processor 120. Such a reduced-power operational state conserves energy while allowing the computing device 102 to return quickly to a full-power operational state.

The out-of-band (OOB) processor 122 is distinct from and generally operates independently of the in-band processor 120. The OOB processor 122 may also be embodied as any type of processor capable of executing software, such as a microprocessor, digital signal processor, microcontroller, or the like, including one or more processors having one or more processor cores (not shown). The OOB processor 122 may be integrated into the chipset 126 on the motherboard or may be embodied as one or more separate integrated circuits disposed on an expansion board that is communicatively coupled to the chipset 126 via a number of signal paths. The OOB processor 122 may also be communicatively coupled to various components of the computing device 102, such as the memory 128 and the communication circuitry 130, via a number of signal paths. Alternatively or additionally, the OOB processor 122 may include built-in components with similar functionality, such as a dedicated memory and/or dedicated communication circuitry (not shown).

The OOB processor 122 is configured for managing particular functions of the computing device 102 irrespective of the operational state of the in-band processor 120. To facilitate such independent operation, the OOB processor 122 may be provided with an independent connection to the power supply, allowing the OOB processor 122 to retain power even when other components of the computing device 102 are powered down or turned off. Furthermore, the OOB processor 122 may be provided with an independent network interface via communication circuitry 130, which is also provided with an independent connection to the power supply, allowing out-of-band communications over the network 106. In other words, the OOB processor 122 is able to communicate directly with devices on the network 106 (such as DNS 104 and remote computing devices 108), outside of the operating system running on in-band processor 120. In fact, this communication may take place without the user's knowledge. The OOB processor 122 is also capable of causing the computing device 102 to return to a full-power operational state, including booting the operating system. In summary, the OOB processor 122 may operate intelligently based on incoming queries/commands and communicate across the network 106 whether the in-band processor 120 is turned off, running on standby, being initialized, or in regular operation and whether the operating system is booting, running, crashed, or otherwise nonfunctioning.

In some illustrative embodiments, the OOB processor 122 may be implemented using Intel® Active Management Technology (Intel® AMT), using a portion of Intel® AMT, or using an Intel® Management Engine (Intel® ME), all available from Intel Corporation of Santa Clara, Calif., and/or within chipsets sold by Intel Corporation. Intel AMT® embedded platform technology enables out-of-band access to hardware and software information stored in non-volatile memory on each endpoint device, eliminating the need for a functioning operating system and many of the software agents found in other management tools.

As discussed above, the computing device 102 may also include one or more data storage devices 132, one or more peripheral devices 134, and an alert indicator 140 in some embodiments. In such embodiments, the chipset 126 is also communicatively coupled to the one or more data storage devices 132, the one or more peripheral devices 134, and the alert indicator 140 via signal paths. The data storage device(s) 132 may be embodied as any type of device or devices configured for the short-term or long-term storage of data such as, for example, memory devices and circuits, memory cards, hard disk drives, solid-state drives, or other data storage devices. The peripheral device(s) 134 may include any number of peripheral devices including input devices, output devices, and other interface devices. For example, the peripheral devices 134 may include a display, mouse, keyboard, and external speakers of the computing device 102. The particular devices included in the peripheral devices 134 may depend upon, for example, the intended use of the computing device 102. The alert indicator 140 may include any type of feedback device capable of alerting a user to the status of the computing device 102. By way of illustrative example, the alert indicator 140 may be embodied as a light source (e.g., a light-emitting diode or LED), an audio source (e.g., a motherboard speaker), or a vibration source (e.g., a force-feedback actuator). Additionally, in some embodiments, the alert indicator 140 may be embodied as or otherwise include the display device of the computing device 102. In such embodiments, an alert message may be displayed on the device (i.e., the alert indicator 140) to alert the user of a disaster event as discussed in more detail below.

In some embodiments, the computing device 102 may also be equipped with dedicated alert circuitry 150, which is communicatively coupled to the OOB processor 122 via a number of signal paths. In some embodiments, the alert circuitry 150 may be incorporated on the motherboard of the computing device 102. In other embodiments, the alert circuitry 150 may be embodied as an expansion card or a peripheral device, which is communicatively coupled to the computing device 102. The alert circuitry 150 may include a speaker 152 and a disaster-event sensor 154. The speaker 152 of the alert circuitry 150 may be embodied as any number of devices that are configured for producing audible sounds in response to a command from the OOB processor 122. For example, the speaker 152 may include an electroacoustic transducer. The disaster-event sensor 154 of the alert circuitry 150 may be embodied as any type of sensor or sensor network configured to sense one or more conditions indicative of the occurrence of one or more disasters. For example, the disaster-event sensor 154 may be embodied as an accelerometer to sense sudden vibrations, a barometer to sense changes in atmospheric pressure, a thermometer to sense changes in atmospheric temperature, or an electrochemical sensor to sense the presence of certain chemical agents. The disaster-event sensor 154 may generate sensor data, which is communicated to the OOB processor 122 for evaluation or further transmission to the DNS 104. Similar to the OOB processor 122 and the communication circuitry 130, the speaker 152 and disaster-event sensor 154 may be provided with an independent connection to the power supply, thereby facilitating the availability of the speaker 152 and disaster-event sensor 154 even in reduced power states.

The disaster notification server (DNS) 104 may be embodied as any type of electronic device capable of communicating, over the network 106, with the computing device 102 and, in some embodiments, the one or more remote computing devices 108. For example, DNS 104 may be embodied as one or more mainframes, servers, personal computers, workstations, laptop computers, or other computer-based devices. DNS 104 will typically include at least one processor and at least one memory device (not shown). In some embodiments, the DNS 104 may include a database 160 which may be stored in the at least one memory device. The database 160 may be used by DNS 104 to retain information received from computing device 102 and remote computing devices 108 including, but not limited to, sensor data from the disaster-event sensors 154, the internet protocol (IP) addresses of the respective computing devices 102, 108, and location data indicative of the physical locations of the corresponding computing devices 102, 108 (e.g., address information, zip codes, GPS coordinates, etcetera). In some embodiments, the DNS 104 is capable of processing and evaluating this data to dynamically generate warning notifications regarding the occurrence of a disaster event. For example, the DNS 104 may use a pre-established comprehensive computational model or other algorithm to evaluate such data.

The network 106 may be embodied as any type of wired and/or wireless network such as a local area network, a wide area network, a publicly available global network (e.g., the Internet), or other network. Additionally, the network 106 may include any number of additional devices to facilitate communication between the computing device 102 and the DNS 104, such as routers, switches, intervening computers, and the like. The one or more remote computing devices 108 may be embodied as any type of computing devices separate from the computing device 102. For example, the remote computing devices 108 may be embodied as one or more personal computers, workstations, laptop computers, handheld computers, mobile internet devices, cellular phones, personal data assistants, telephony devices, network appliances, virtualization devices, storage controllers, or other computer-based devices also configured to communicate with the DNS 104 over the network 106. The one or more remote computing devices 108 may each have a similar configuration to that of the computing device 102, including an OOB processor and a disaster event sensor.

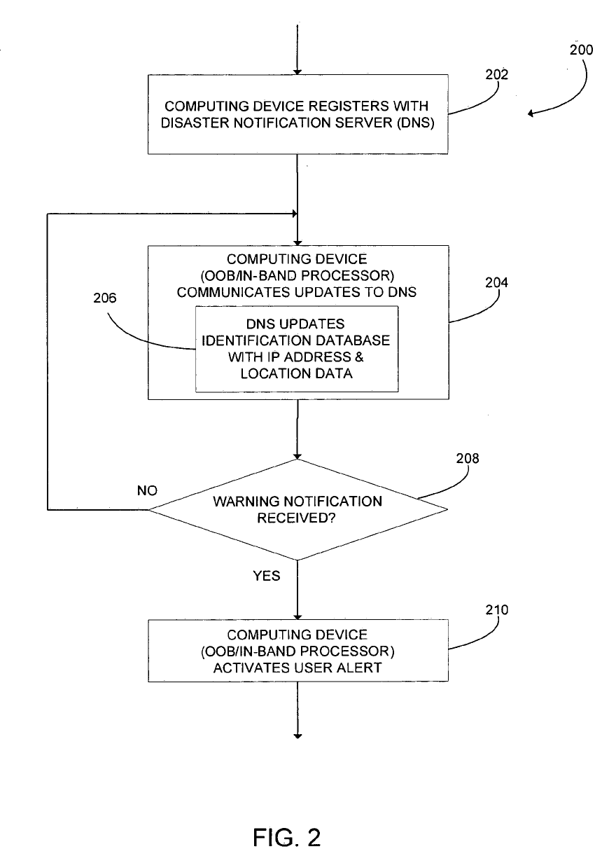

Several of the features of the OOB processor 122, including its persistent power supply and independent communication channel, allow the system 100 to detect disaster events, provide a disaster warning, or both. To do so, as illustrated in FIG. 2, the system 100 may be configured to execute a method 200 for providing a disaster warning. The method 200 may be executed by, for example, the OOB processor 122, in conjunction with other components of the computing device 102, which may interact with other components of the system 100. The method 200 may utilize computing device 102 to provide a warning for any type of disaster (e.g., earthquake, volcano, tornado, hurricane, tsunami, flash flood, critical computer virus, terrorist attack, etcetera) based on appropriate sensor data. Additionally, the disaster warning generated by the method 200 may originate from any source (e.g., a government agency).

The method 200 begins with block 202 in which a user of the computing device 102 registers the device 102 with the disaster notification server (DNS) 104. To do so, the computing device 102 transmits identification data over the network 106 to the DNS 104. This identification data may include, for example, the internet protocol (IP) address of the computing device 102, location data indicative of the physical location of the computing device 102 (e.g., address information, a zip code, GPS coordinates, etcetera), and/or system information. The DNS 104 stores the identification data in a record of the database 160 corresponding to computing device 102. In some embodiments, block 202 may involve a user visiting a website or other portal related to DNS 104 and submitting relevant data using a web browser. In other embodiments, block 202 may involve the computer device 102 transmitting identification data over the network 106 to the DNS 104 without intervention by the user (e.g. in response to an interrogation message received from the DNS 104). Additionally, in some embodiments, the DNS 104 may be configured to determine the location data of the computing device 102 based on the received IP address of the device 102. Such location data may be determined by accessing, for example, a public or private IP-to-location database or web service (e.g., www.ipgeoinfo.com).

It should be appreciated that the identification data may periodically change from what is stored in database 160 of the DNS 104, such as when the IP address of the computing device 102 is updated or when the computing device 102 is moved to a new location (e.g., the computing device 102 may be a mobile computing device). As such, the computing device 102 communicates updated identification data to the DNS 104 in block 204. The updated identification data may be transmitted by the in-band processor 120 or the OOB processor 122. For example, if the computing device is in a fully operational power state, the in-band processor 120 may transmit the updated identification data to the DNS 104; and the OOB processor 122 may transmit these updates when the in-band processor 120 of the computing device 102 is in a reduced power state or turned off. Additionally, the in-band processor 120 and/or OOB processor 122 may transmit these updates to the DNS 104 without the need for user intervention. In some embodiments, the computing device 102 transmits the updated location data only when a change in such data has occurred (e.g., when the IP address of the computing device 102 has changed). As shown in block 206 of FIG. 2, in response to receiving the updated identification data, the DNS 104 updates the relevant record(s) in the database 160.

Once the computing device 102 is registered with the DNS 104, the computing device 102 (i.e., the in-band processor 120 or the OOB processor 122) will also begin receiving relevant warning notifications from the DNS 104. In block 208, the computing device 102 determines whether the DNS 104 has sent a warning notification in response to the detection of a disaster event. That is, when the DNS 104 determines that a disaster event is occurring or about to occur (through its own determination or a notification received from an external source), DNS 104 is configured to access the database 160 to determine which computing devices 102, 108, if any, reside in or otherwise belong to a computing system that resides in the area likely affected by the disaster event (e.g., earthquake, critical virus attack, etc.). If any computing devices 102, 108 are located in the affected area, the DNS 104 will broadcast a warning notification to the corresponding IP address(es) stored in database 160. Thus, if the computing device 102 is located in an area experiencing or about to experience a disaster event, DNS 104 will transmit a warning notification to the computing device 102 (i.e., to the in-band processor 120 or the OOB processor 122). It should be appreciated that the OOB processor 122 is available to receive such a warning notification even when the in-band processor 120 of the computing device 102 is powered down or turned off. Additionally or alternatively, the computing device 102 may be configured to periodically query the DNS 104 for warning notifications.

If a warning notification has not been received in block 208, the method 200 loops back to block 204. However, if a warning notification has been received by the computing device 102 (i.e., by the in-band processor 120 or the OOB processor 122), a user alert is generated on the computing device 102 in block 210. The user alert generated by the computing device 102 in block 210 may take any form that is designed to capture the attention of a user of computing device 102.

In situations where the computing device 102 is powered on when the warning notification is received, the warning notification may be handled by the OOB processor 122 and/or the in-band processor 120. For example, the OOB processor 122 may be configured to promptly send an alarm signal to the speaker 152, or the alert indicator 140, and/or one or more peripheral devices 134 of the computing device 102 in response to receiving the warning notification when the computing device 102 is powered on. In this situation, the user alert may take the form of an audible alarm, a visual warning, a vibration, or any combination thereof. Alternatively, in some embodiments, the in-band processor 120 is configured to receive and handle the warning notification if the computing device 102 is powered on. In such situations, the in-band processor 120 may perform functions similar to the OOB processor 122 including sending an alarm signal to the speaker 152, or the alert indicator 140 and/or one or more peripheral devices 134 of the computing device 102. Additionally, in some embodiments, the OOB processor 122 is configured to handle the warning notification regardless of the power state of the in-band processor 120.

In situations where the computing device 102 is in a reduced-power operational state when the warning notification is received by the OOB processor 122 from the DNS 104 (and the computing device 102 is not equipped with the optional alert circuitry 150), the OOB processor 122 may boot the in-band processor 120 to a power operational state required to restore the functionality necessary to generate a user alert. In many disaster situations, however, the user of the computing device 102 must be quickly notified to avoid potential harm. As such, in some embodiments, the OOB processor 122 may signal an emergency flag to the chipset 126, resulting in the BIOS instructions initiating a quick, emergency boot scheme. In some embodiments, this emergency boot scheme may involve only initialization of the components and software necessary to operate the alert indicator 140 (e.g., a motherboard speaker). In such embodiments, the alert indicator 140 may be used to generate a beeping pattern (i.e., one or more beeps), which is pre-selected to indicate the detection of the disaster event. By way of example, the computing device 102 may output one long, continuous beep to indicate the occurrence of an earthquake in the area. Additionally, in some embodiments, the OOB processor 122 may boot the in-band processor 120 to a power operational state required to restore the functionality of the computing device 102 such as the display of the computing device 102. In such embodiments, an alert message may be presented to the user in addition to, or alternatively to, the generation of an audio alert.

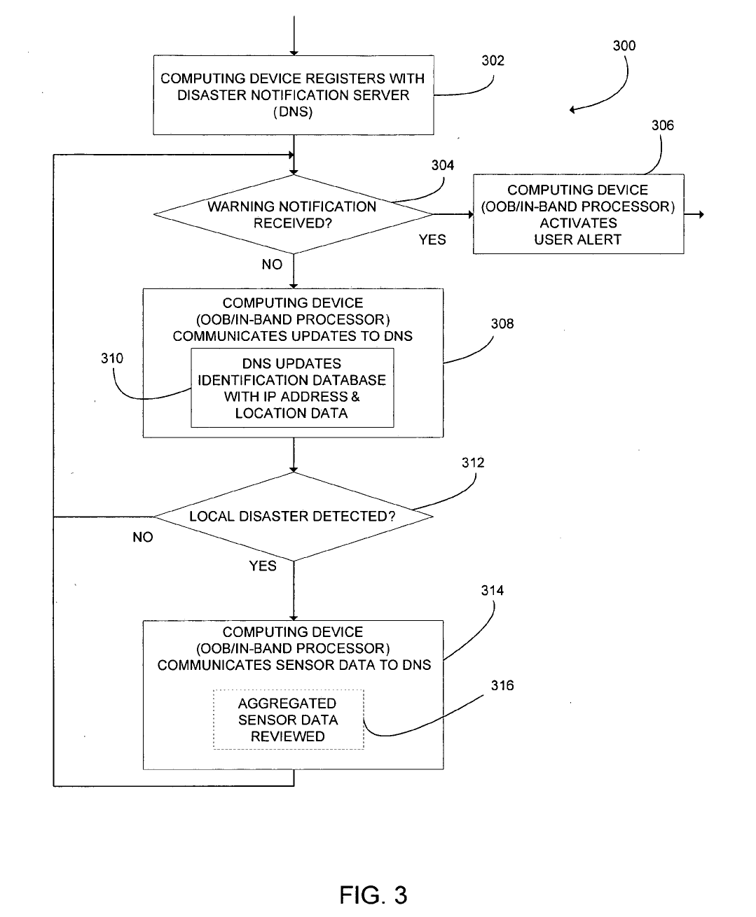

Referring now to FIG. 3, in use, the system 100 may also be configured to execute a method 300 for detecting a disaster event and providing a disaster warning. The method 300 may also be executed by, for example, the OOB processor 122 in conjunction with other components of the computing device 102, which may interact with other components of the system 100. With the appropriate disaster-event sensor 154, method 300 may be used to detect and to provide a warning for any type of disaster (e.g., earthquake, volcano, tornado, hurricane, tsunami, flash flood, critical computer virus, terrorist attack, etcetera). The method 300 begins with block 302 in which a user of the computing device 102 registers the device 102 with the disaster notification server (DNS) 104.

Once the computing device 102 is registered with the DNS 104, the computing device 102 (i.e., the in-band processor 120 or the OOB processor 122) determines whether or not the DNS 104 has sent a warning notification in response to the detection of a disaster event in block 304. As discussed above in regard to FIG. 2, when the DNS 104 determines that a disaster event is occurring or about to occur (through its own determination or a notification received from an external source), DNS 104 is configured to access the database 160 to determine which computing devices 102, 108, if any, reside in or otherwise belong to a computing system that resides in the area likely affected by the disaster event (e.g., earthquake, critical virus attack, etc.). If any computing devices 102, 108 are located in the affected area, the DNS 104 will broadcast a warning notification to the corresponding IP address(es) stored in database 160. Thus, if computing device 102 is located in an area experiencing or about to experience a disaster event, DNS 104 will transmit a warning notification to the computing device 102 (i.e., the in-band processor 120 or the OOB processor 122). Again, it should be appreciated that the OOB processor 122 is available to receive such a warning notification even when the in-band processor 120 of the computing device 102 is powered down or turned off. Additionally or alternatively, the computing device 102 may be configured to periodically query the DNS 104 for warning notifications.

If the computing device 102 (i.e., the in-band processor 120 or the OOB processor 122) determines that a warning notification has been received, the computing device 102 generates a user alert on the computing device 102 in block 306. The user alert generated by the computing device 102 may take any form that is designed to capture the attention of a user of computing device 102. For example, in embodiments in which the computing device 102 is equipped with dedicated alert circuitry 150 (which also has a persistent power supply), the computing device 102 (i.e., the in-band processor 120 or the OOB processor 122) can immediately send an alarm signal to the speaker 152, resulting in the speaker 152 generating an audible alarm. As discussed above in regard to block 210 of FIG. 2, in situations where the computing device 102 is powered on when the warning notification is received, the warning notification may be handled by the OOB processor 122 and/or the in-band processor 120. For example, the OOB processor 122 may handle the warning notification regardless of the power state of the computing device 102. Alternatively, the OOB processor 122 may be configured to handle the warning notification when the computing device 102 is in a reduced power state and the in-band processor 120 may be configured to handle the warning notification when the computing device 102 is in a powered or operational state as discussed in more detail above in regard to block 210 of FIG. 2.

Referring back to block 304, if the computing device 102 (i.e., the in-band processor 120 or the OOB processor 122) determines that no warning notification has been received, the computing device 102 communicates updated identification data to the DNS 104 in block 308. In response to receiving the updated data, the DNS 104 updates the database 160 in block 310. The specific operations of blocks 308 and 310 are substantially similar to blocks 204 and 206, respectively, of method 200, described above with reference to FIG. 2.

Once the computing device 102 has communicated any updated identification data to the DNS 104, the computing device 102 (i.e., the in-band processor 120 or the OOB processor 122) will also begin monitoring sensor data generated by the disaster-events sensor(s) 154. In block 312 of method 300, the computing device 102 (i.e., the in-band processor 120 or the OOB processor 122) evaluates the sensor data from the disaster-events sensor(s) 154 to determine whether a local disaster condition has occurred. In some embodiments, block 312 may involve comparing one or more values of the obtained sensor data to a predetermined or dynamically-adjusted threshold value. Returning to the example of earthquake detection, the OOB processor 122 or the in-band processor 120 may monitor the output of an accelerometer (i.e., the disaster-event sensor 154) for sudden fluctuations to detect one or more P-waves of an earthquake. The processors 120, 122 may make these observations and evaluations even when the in-band processor 120 of the computing device 102 is in a reduced power state or turned off.

If the computing device 102 (i.e., the in-band processor 120 or the OOB processor 122) determines that a local disaster condition has not occurred in block 312, the method 300 loops back to block 304. However, if the computing device 102 detects a local disaster condition, the method 300 proceeds to block 314 in which the computing device 102 (i.e., the in-band processor 120 or the OOB processor 122) communicates some or all of the sensor data to the DNS 104. It should be appreciated that the OOB processor 122 may transmit relevant sensor data even when the in-band processor 120 of the computing device 102 is in a reduced power state or turned off. The computing device 102 may transmit these updates to the DNS 104 without the need for user intervention. It should be noted that in some embodiments of the method 300, the decisional block 312 may be omitted and all sensor data obtained by the OOB processor 122 or in-band processor 120 may be transmitted to the DNS 104 (in such embodiments, the method 300 proceeds directly from block 308 to block 314).

After the computing device 102 (i.e., the in-band processor 120 or the OOB processor 122) communicates the sensor data to the DNS 104, the DNS 104 may aggregate and review the sensor data received from the computing device 102 and, in some embodiments, one or more remote computing devices 108 in block 316. That is, if local disaster conditions are reported by several computing devices 102, 108, the DNS 104 may determine the occurrence of a disaster event with a higher rate of confidence (thus, helping to avoid false positives). The DNS 104 may also evaluate various aspects of the sensor data, such as magnitude and timing, with location geography information to determine various characteristics of the disaster event. Optionally, an expert may also interact with the DNS 104 to observe and evaluate the received sensor data. Returning to the illustrative example of earthquake detection, if several computing devices 102, 108 report local vibrations and the devices 102, 108 are located on a seismic belt, the DNS 104 may conclude that these vibrations represent the P-waves of an earthquake. The DNS 104 may then calculate various characteristics of the earthquake (e.g., magnitude, epicenter). Finally, the DNS 104 may transmit a warning notification to each computing device in the affected area, which is then received by the computing device 102 in block 304. In most cases, this warning notification will reach the computing device 102 before the destructive Rayleigh waves, allowing the OOB processor 122 or in-band processor 120 to generate a user alert warning of the impending earthquake.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure and the appended claims are desired to be protected.

1. A method comprising:
transmitting identification data from an out-of-band (OOB) processor of a computing device to a server remote from the computing device, the OOB processor being capable of communicating with the server irrespective of an operational state of an in-band processor of the computing device;
receiving, with the OOB processor, a warning notification transmitted from the server (i) in response to detection of a disaster event and (ii) based on the identification data; and
generating a user alert on the computing device in response to receiving the warning notification.

2. The method of claim 1, wherein transmitting identification data comprises transmitting (i) an internet protocol (IP) address of the computing device and (ii) data indicative of a physical location of the computing device.

3. The method of claim 2, wherein transmitting identification data comprises periodically transmitting the IP address of the computing device.

4. The method of claim 1, wherein receiving the warning notification comprises receiving, with the OOB processor, the warning notification while the in-band processor is in a reduced-power operational state.

5. The method of claim 1, wherein generating a user alert comprises generating an audible alarm on the computing device.

6. The method of claim 5, wherein generating an audible alarm comprises booting the in-band processor of the computing device from a reduced-power operational state such that a beeping pattern is generated from a motherboard speaker of the computing device, the beeping pattern being pre-selected to indicate the detection of the disaster event.

7. The method of claim 5, wherein generating an audible alarm comprises transmitting an alarm signal from the OOB processor to a peripheral sound module of the computing device.

8. The method of claim 1, further comprising:
monitoring a disaster-event sensor of the computing device to obtain sensor data; and
transmitting the sensor data from the OOB processor to the server.

9. The method of claim 8, wherein the warning notification is further based on sensor data received by the server from a plurality of computing devices, each of the plurality of computing devices including a disaster-event sensor and a corresponding OOB processor.

10. The method of claim 9, wherein monitoring the disaster-event sensor comprises monitoring an accelerometer of the computing device, the accelerometer being configured to sense a primary wave of an earthquake.

11. A tangible, machine readable medium comprising a plurality of instructions that, in response to being executed, result in a computing device:
receiving a warning notification with an out-of-band (OOB) processor of the computing device while an in-band processor of the computing device is in a reduced-power state, the warning notification being received over a network; and
generating an audible alarm on the computing device with the OOB processor in response to receiving the warning notification.

12. The tangible, machine readable medium of claim 11, wherein:
receiving the warning notification comprises receiving the warning notification from a remote server; and
the plurality of instructions further result in the computing device updating identification data of the computing device stored on the remote server.

13. The tangible, machine readable medium of claim 12, wherein updating identification data comprises periodically transmitting an internet protocol (IP) address of the computing device to the remote server.

14. The tangible, machine readable medium of claim 11, wherein generating an audible alarm comprises booting the in-band processor of the computing device from a reduced-power operational state such that a beeping pattern is generated from a motherboard speaker of the computing device, the beeping pattern being pre-selected to indicate detection of a disaster event.

15. The tangible, machine readable medium of claim 11, wherein generating an audible alarm comprises transmitting an alarm signal from the OOB processor to a peripheral sound module of the computing device.

16. The tangible, machine readable medium of claim 11, wherein the plurality of instructions, in response to being executed, further result in the computing device:
receiving sensor data from a disaster-event sensor communicatively coupled to the computing device; and
transmitting the sensor data to a server remote from the computing device using the OOB processor.

17. The tangible, machine readable medium of claim 16, wherein receiving the warning notification comprises receiving a warning notification generated in response to the sensor data by a server remote from the computing device.

18. The tangible, machine readable medium of claim 16, wherein receiving sensor data comprises receiving sensor data from an accelerometer of the computing device, the accelerometer being configured to sense a primary wave of an earthquake.

19. A computing device comprising:
an in-band processor;
a disaster-event sensor; and
an out-of-band (OOB) processor capable of communicating over a network with a disaster-notification server irrespective of an operational state of the in-band processor, the OOB processor configured to:
receive sensor data from the disaster-event sensor and transmit the sensor data to the disaster-notification server;
receive a warning notification from the server in response to the sensor data; and
generate a user alert on the computing device in response to receiving the warning notification.

20. The computing device of claim 19, wherein the warning notification is based on sensor data received by the server from a plurality of computing devices.

21. The computing device of claim 19, wherein the OOB processor is further configured to determine an occurrence of a disaster event based on the sensor data and generate the user alert on the computing device based on the occurrence of the disaster event.
